(19) United States
(12) Patent Application Publication
(10) Pub. No.: US 2014/0302466 A1
(43) Pub. Date: Oct. 9, 2014

(54) Method, system, and apparatus for authoring, transforming, and reading text enhanced with guidance symbols and formatting

(71) Applicant: Christopher G. Collins, Humble, TX (US)

(72) Inventor: Christopher G. Collins, Humble, TX (US)

(21) Appl. No.: 14/209,203

(22) Filed: Mar. 13, 2014

Related U.S. Application Data
(60) Provisional application No. 61/810,193, filed on Apr. 9, 2013.

(51) Int. Cl. G09B 17/04; G09B 17/00

(52) U.S. Cl. CPC G09B 17/04; G09B 17/003
USPC 434/169

(57) ABSTRACT

A text reading system for authoring, transforming, and reading enhanced text that contains reading guidance symbols and formatting, for the purpose of providing a reader with guidance on the location of words and the direction of reading in the enhanced text, and enhancing reading comprehension and reading speed, includes an authoring component, a text transformation component, an enhanced text repository, and an enhanced text reader. The enhanced text reading system takes as data input either standard text from a standard text repository, or text written by a human author, while using the authoring component. The reading system produces text that is enhanced with reading guidance symbols and formatting, and stored in an enhanced text repository. Furthermore disclosed is a method for authoring, transforming, and reading text; and an apparatus for reading enhanced text, including a processor, a memory, an input/output, a screen, an enhanced text viewer, and other optional components.

### CROSS-REFERENCE TO RELATED APPLICATIONS

This application claims the benefit of U.S. Provisional Application No. 61/810,193, filed Apr. 9, 2013.

### FIELD OF THE INVENTION

The present invention relates generally to the field of writing, publishing and reading. More particularly the invention relates to the optimization of written text for the purpose of improving reading speed and comprehension.

### BACKGROUND OF THE INVENTION

Writing is a system of linguistic symbols, which permit an author to transmit and conserve information that can subsequently be obtained by a reader. Writing is believed to have developed between the seventh millennium BC and the fourth millennium BC, first in the form of early mnemonic symbols, which became a system of ideograms or pictographs through simplification. The oldest known forms of writing were primarily logographic in nature. Later syllabic and alphabetic writing emerged and become predominant.

A number of media have been employed for the recording and publication of writing throughout historic times. In China silk was used a base for writing with brushes. Many other materials have been used as base and storage medium for writing, such as bone, bronze, pottery, shell, etc. In the Nordic countries, for example, the Vikings of the Nordic countries used large stones for writing, employing a non-standardized sound-based alphabet. Historically, almost any material that can hold and transmit text has been used for the publishing of writing.

Reading is a complex cognitive process of decoding symbols in order to construct or derive meaning. It is a method of language acquisition, of communication, and of sharing information and ideas. The process of reading t is a complex interaction between the text and the reader, which is shaped by the reader's prior knowledge, experiences, attitude, and the environment and its cultural and social context.

The ability to read, the speed of reading, and the degree of comprehension of the intended meaning, can vary with individuals. Individuals with different types of learning disabilities may not read at the same speed or acquire the same degree of comprehension as a person with normal learning abilities. Dyslexia, for example, refers to a cognitive difficulty with reading and writing. It is defined as brain-based type of learning disability that specifically impairs a person's ability to read.

The reading process has not changed significantly during historic times. A handwritten book with illustrations is not significantly different from a paper book or an electronic book published in present times. Changes to practices in publishing and reading have generally focused on either the aesthetics of presentation or the ease of reference. Very little progress has been made in methods and devices to aid the speed and comprehension of reading.

A persistent problem common to all readers, past and present, is the reading error of directing eye focus to the wrong location. Readers continue to accept this reading error as being an unavoidable part of the reading process. The reading error of directing eye focus to the wrong location reduces reading speed and comprehension, because upon making this reading error, the reader is interrupted in the reading process and must take time to reorient eye focus to the correct location. Subsequent to this reorientation of eye focus, the reader must then recall the subject matter that was being read when the reading error occurred in order to restart the reading. With increasing line length and increased reading time, the frequency of occurrences of this reading error will increase.

Boustrophedon, a Greek word literally translated, “as the ox plows”, is an ancient Greek attempt to improve the reading process using a form of bi-directional text. Boustrophedon is impractical in its two ancient forms. In ancient Greece, a reader using one version of boustrophedon reads a line left to right and then turns the scroll being read 180 degrees to read the next line in the same direction, left to right. Another version of boustrophedon has a reader read a line left to right. The reader then drops down one line to read the next line beginning at the right margin right to left with the words written on this line right to left also and repeats this process.

These ancient Greek reading methods are too awkward to be used in any practical way and have not been used by readers in the past or in the present in significant numbers. Boustrophedon, however, is an acknowledgement that improvements in the reading format have been attempted for thousands of years and continue to the present day. Today it is not uncommon for documents to have numbered lines using various formats. Certain legal documents have the lines numbered in some fashion to aid the reading process. This form of numbering is however solely used for reference purposes.

Additionally, all readers have difficulty from time to time locating and making correct eye focus on indicia for footnotes. For example, the footnote is indicated to be on a particular document but a reader frequently must spend an unnecessarily long amount of time searching a document to locate it.

As such, considering the foregoing, it may be appreciated that there continues to be a need for novel and improved devices and methods for improving reading speed and reading comprehension.

### SUMMARY OF THE INVENTION

This invention describes a number of significant enhancements to the known methods of writing and reading, for the specific purpose of improving reading speed and reading comprehension.

This invention provides substantial improvement over past reading methods and can be beneficial for both normal readers and readers with learning or reading disabilities.

Human beings are designed to see pictorially. This invention teaches the use of pictorial enhancements, both inside and external to the text, to make reading a more pictorial experience, and thereby inform and guide the reader with respect to the flow of reading.

The foregoing needs are met, to a great extent, by the present invention, wherein in aspects of this invention, enhancements are provided to the existing model of authoring, publishing and reading textual material, whereby the text is enhanced with formatting, pictorial guides, and visual signs that aid the reader by:
a. guiding the reader, so that the reader remains informed of the current location of reading, and the upcoming direction and flow of reading,
b. establishing a constant reading pace,
c. minimizing unnecessary eye movement,
d. minimizing the occurrence of the reader “getting lost on the page”,
e. easing return to last point of reading; and thereby:
f. optimizing reading comprehension,
g. saving time, and
h. maximizing reading speed.

At the heart of many aspects of this invention is the discovery that the placement of information additional to the text of the current reading format can compensate for the incompatibilities and deficiencies of the current reading format and reduce the incidence of a reader locating eye focus to the incorrect location and then reading the incorrect word. Symbolic location information can guide the reader to move eye focus to the correct location even if eye focus shift is rapid, and therefore can greatly reduce the occurrence of reading the incorrect word.

Human beings prefer to view the world in a pictorial way and have greater natural capacity to process visual information pictorially than they do processing information using the current zigzag reading format. Humans naturally process visual information in a pictorial process that is analogous to a digital format, while reading in the current format is described better as an analog process. Reading in the current zigzag reading format is not compatible with how humans naturally prefer to process visual information, and is thus prone to persistent and frequent errors. The requirement of the current reading format to read in a zigzag fashion coupled with the lack of location identification information to guide the reader creates the current high incidence of readers making eye focus to the wrong location and then reading the wrong words.

The reason a reader frequently reads the wrong words is that a reader moves eye focus to the incorrect location because of the long eye-focus traverse requirements of the current zigzag reading process. The primary reason for a reader locating eye focus to the incorrect location when reading text in the current zigzag reading format is because of, (1) the long eye focus traverse requirement of the current reading format and, (2) that there is no location identifier information to guide the reader to the correct location to be read. The current reading format is analogous to a map without location identifiers.

Currently, when a reader finishes reading a line using the current reading format, the reader must make an awkward, relatively long, usually rapid and unnatural traverse of eye focus to the opposite margin, to begin reading a new line. In the process, all too often the reader moves eye focus to the incorrect location and reads the wrong word. The reason for this reading error is that the reader attempts to shift eye focus too fast, and also that there is no eye focus location information to guide the reader. Most readers make this awkward right to left traverse of eye focus as fast as possible on almost all lines read. Most often, the reader makes the reading error of reading the wrong words by locating eye focus on the wrong line one line too far down. The reading error of incorrect eye focus location is more frequent the longer the line that is being read and the longer the time elapsed since beginning reading. However, the most common reason a reader makes the reading error of incorrect eye focus location while using the current reading format is because most readers try to speed up the reading process by making the zigzag eye focus traverse to the opposite margin requirement too fast and loose control of precise eye focus location capacity and as a result read the incorrect word.

In an aspect of this invention, each line is provided with visual symbols additional to the text that enable the reader to be aware of the desired reading location. Visual symbols like line numbering or line lettering, for example, provides the reader with line identifying marks to constantly and instantaneously keep the reader informed of the precise location of all words to be read. One specific embodiment of the principles of this invention is to number each line with the appropriate line number at the beginning and end of the line. For example, a line 19 can be numbered with the number 19 marked at the beginning and at end of the line. All lines in a text can be numbered in the same format. When a reader reaches the end of line 19, the reader notes the line number and then moves eye focus to the opposite margin and the next line number, in this instance line 20 to begin reading the next line. The reader with the use of line numbering can be confident the correct line is being read. Implementation of additional visual elements in accordance with the principles of this invention can include the use of line color, font enhancement, directional symbols, and word location elements. These additional visual elements enable the reader to confidently locate eye focus and read the correct words.

Another aspect of this invention uses visual elements to locate bookmark indicia quickly and precisely. Finding the location of a bookmark on a page is difficult because currently there is no visual information to identify the exact location of the footnote. By including a location identifier in the footnote indicia a location identifier, a reader can quickly move eye focus to the desired footnote indicated by the footnote indicia. For example, L19w5 at the end of a footnote identifies the location of the footnote to be at line 19 word 5 as per an agreed use of the principles of this invention.

An additional aspect of this invention is the use of visual location information, to enable a new more practical and useful version of the ancient Greek boustrophedon reading method. An aspect, pertaining to an improved boustrophedon reading method can add line numbering at the beginning and end of each line. Additionally, reading direction arrows can be placed to guide the reader to move eye focus to the correct location. Further, the font of the text being read left to right is can be italicized to indicate to the reader the correct reading direction. Finally, the color of the text being read left to right can be different than the text being read right to left to notify the reader by color of the correct reading direction. This symbolic visual information enables the reader the means to move eye focus to the correct location, even if looking away and pausing reading temporarily. Additionally, the implementation of this specific aspect of this invention can eliminate the zigzag requirement of the current reading form and allow the reader to read in a smooth flowing eye movement of an improved modern boustrophedon reading format. The implementation of this invention to improve the ancient Greek boustrophedon reduces the likelihood of a reader directing eye focus to the incorrect location because the zigzag eye focus traversal is eliminated.

A notable fact is the time saving enabled by the implementation of the principles of this invention. If one million readers can save one second per day by using the improvements taught by the various aspects of this invention, then there has been a yearly reduction of reading time for one million readers of over 11.5 years cumulatively. Alternatively stated, a timesaving of 1 minute per day of reading time means one million readers have read an amount of material 690 years faster. Additionally, there is a great pent up demand among readers for any means that reduces the incidence of directing eye focus to the incorrect location during the reading process. A reasonable estimate is that on average a reader spends over 5 seconds reestablishing correct eye focus after locating eye focus on the incorrect location.

In an aspect of this invention, an author is enabled with a text authoring component that allows manual or semi-automatic authoring of textual content enhanced with visual guides, symbols, and formatting, for the purpose of improving reading speed and comprehension.

In another aspect of this invention, a text transformation component performs automatic transformation of normal textual content by applying a set of pre-determined transformation rules, thereby applying visual guides, symbols, and formatting, for the purpose of improving reading speed and comprehension.

In an aspect of this invention, text lines are enhanced with preceding and succeeding line numbers, so that the reader while nearing end of line, is informed of an upcoming line change, and guided as to which line follows-next.

In another aspect, an arrow symbol is placed, at the end of line to guide the reader on the upcoming flow of reading and indicate where reading continues on the upcoming text line.

In another related aspect, line numbers are applied to the start and end of text lines, in order to guide the reader about the direction and flow of reading. Line numbering is a known concept to guide a reader concerning the location of a reference point in a document, but in aspects of this invention is employed using a novel design, for the purpose of improving the reading experience. This novel form and use of line numbering can improve the reading speed and comprehension, both during normal reading, and during fast “skimming” of a document, thereby producing a more efficient and more enjoyable reading experience.

In another further related aspect, bi-directional text is enhanced with guidance symbols and special color formatting. Bi-directional writing and reading is a well-known concept, originating with the ancient Boustrophedon style of reading and writing, where every other line of writing is flipped or reversed, with or without reversed letters. Rather than going left-to-right as for example in modern English, or right-to-left as for example in Arabic and Hebrew, alternate lines in boustrophedon must be read in opposite directions. In addition, the individual characters can be reversed, or mirrored. Boustrophedon was a common way of writing in stone in Ancient Greece.

Aspects of this invention enhances the known concept of bi-directional reading with guidance symbols and formatting, thereby providing a significantly improved reading experience. By using the novel form of bi-directional reading taught by aspects of this patent a reader can eliminate the tiring back and forward movement of the eyes that is a consequence of reading standard left-to-right text, and increase reading speed and comprehension further by use of guidance symbols and formatting.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a system for authoring, transforming, presenting, and reading text enhanced with guidance symbols and formatting, according to an embodiment of the invention.

FIG. 2 is a flowchart illustrating steps that may be followed in accordance with one embodiment of the method or process of authoring, transforming, presenting, and reading text enhanced with guidance symbols and formatting.

FIG. 3 is a schematic diagram illustrating an apparatus for reading text enhanced with guidance symbols and formatting, according to an embodiment of the invention.

FIG. 4 is a drawing illustrating examples of text enhanced with guidance symbols and formatting, according to various embodiments of the invention.

FIG. 5 is a drawing illustrating examples of text enhanced with guidance symbols and formatting, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

An embodiment of a system for authoring, transforming, and reading text enhanced with guidance symbols and formatting describes a computer-implemented system for producing and reading text enhanced with reading guidance symbols, and formatting, for the purpose of enhancing reading comprehension and reading speed.

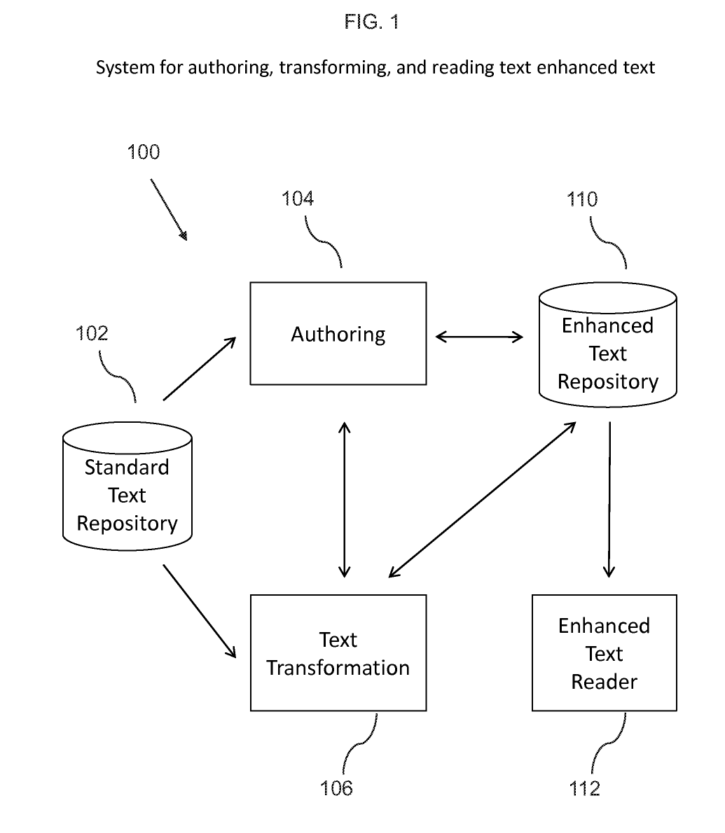

In the following we describe the structure of such an embodiment in the form of a computer-implemented system with reference to FIG. 1, in such manner that like reference numerals refer to like components throughout; a convention that we shall employ for the remainder of this specification.

Throughout this disclosure, enhanced text shall be understood to mean standard text enhanced with visual guidance symbols and formatting, to guide the reader in the flow of reading.

A guidance symbol shall be understood to mean a symbol inserted in the teach for providing information on the location and flow of reading, including any one of the guidance symbols described in detail herein, such as arrow symbols and line numbering.

Guidance formatting shall be understood to mean special formatting for providing information on the location and flow of reading, for example including line color-coding, and other embodiments of guidance formatting described in detail herein.

Content shall be understood to mean any form of language conveyed in any form of content medium, such as for example:
a. electronic content in the form of an electronic document, such as a Word document or a text file;
b. Books, containing text and/or pictures;
c. Posters, containing text and/or pictures; or
d. Other forms of content medium containing content expressed in a graphical and/or character based language.

A system for reading text enhanced with guidance symbols and formatting 100 can include an authoring component 104, a text transformation component 106, an enhanced text repository 110, and an enhanced text reader 112. The system takes as data input either standard text from a standard text repository 102, or text that is produced by a human author while using the authoring component. The enhanced text reading system 100 produces an enhanced text that is stored in the enhanced text repository 110.

The authoring component 104 can allow manual authoring of enhanced text. The authoring component works based on input of standard text derived from the standard text repository 102, or based on manual input of text content by a human author using the authoring component 104.

The standard text repository 102 can include a multitude of external data sources, such as text databases, web sites, interactive web services, xml documents, and other storage means for text, or other accessible data repositories from which textual contents can be extracted.

The text transformation component 106 can transform text
a. from either a standard text format, obtained from the standard text repository 102, or from enhanced text, obtained from the authoring component 104 or the enhanced text repository 110,
b. into enhanced text, by applying a set of pre-determined transformation rules that do automated insertion of reading guidance symbols and reading guidance formatting based on matching to specific semantic or syntactic occurrences in the input text. For example, such a rule could at each line-shift, a syntactic match, insert a thin arrow going from the end of the current line to the beginning of the next following line, to direct the movement of the eye for the reader.

The text transformation component 106 stores the enhanced text in the enhanced text repository 110.

The enhanced text repository 110 can store an internal representation of enhanced text, obtained from the authoring component 104 or the text transformation component 106, in a multitude of formats, including PDF, Microsoft Word, HTML, HTML 5, XML, SVG, interactive SVG, mixed formats, proprietary formats, and other textual or multimedia formats.

The enhanced text reader 112 takes as input enhanced text, obtained from the enhanced text repository 110, and presents this enhanced text for purposes of reading.

In related embodiments, the enhanced text reader 112 can be configured to execute as:
a. A web software application, executing in a Web browser;
b. A tablet software app, executing on a tablet device, such as for example an Android or iOS tablet device;
c. A mobile software app, executing on a mobile device, such as for example an Android phone or iPhone, or any wearable mobile device;
d. A desktop software application, executing on a personal computer, or similar device;
e. An embedded software application, executing on a processing device, for example a handheld electronic reading device, a smart TV, a game console or other system.

Each of the authoring component 104, the text transformation component 106, and the enhanced text reader 112 can include a multitude of conventional or non-conventional internal storage mechanisms, those storage mechanisms either persistent or non-persistent, such as including in memory class and object structures, xml documents; flat file formats; relational, non-relational and other databases; and other general types of editable text storage formats for the purpose of storing interim and final processing results, including internal representations of enhanced text.

Each of the authoring component 104, the text transformation component 106, and the enhanced text reader 112 can include a multitude of conventional or non-conventional communication mechanisms. Those communication mechanisms can be either synchronous or asynchronous, such as including communication pipes, socket communication, shared memory, shared object, and other process-to-process communication mechanisms for the purpose of allowing communication between the different components in the system.

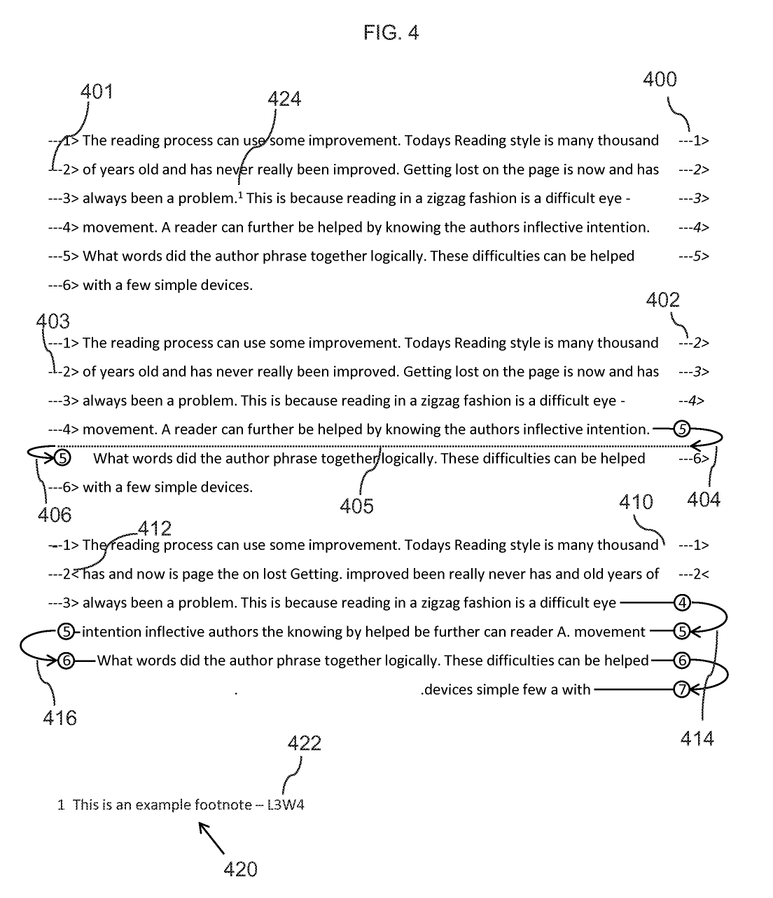

In an embodiment of the system for authoring, transforming, and reading text enhanced with guidance symbols and formatting, as shown in FIG. 4, text can be enhanced with an ending line number 400, indicating the end of line, and a beginning line number 401, indicating the beginning line, so that the reader while nearing end of line, is informed of an upcoming line change, and guided as to which line follows-next. The beginning line number 400 and the ending line number 401 are guidance symbols.

In a related embodiment, an ending line number 402 can indicate the line number of a next following line 403, so that
a. the reader while nearing end of line, is informed of an upcoming line change, and
b. by looking for the same line number 403, starting the following line, as the line number 402 for the currently ending line, is thereby guided as to which line follows-next.

In another embodiment, an arrow symbol 404 can be placed, at the end of a line to guide the reader on the upcoming flow of reading and indicate where reading continues on a next following text line.

In a related embodiment, the ending line can be enhanced with
a. an arrow symbol and a number 404, and continued with
b. a line indicator 405, indicating the direction to the start of
c. the next line 406, which is enhanced with an arrow symbol and the same number, to indicate the start of the following line, whereby the reader while nearing end of line, is informed of an upcoming line change, and by following the arrow symbol and number 404, and the line indicator 405, looking for the same line number 406 starting the following line, as the line number 404 for the currently ending line, is thereby guided as to which line follows next. The arrow symbols can have a plurality of shapes and forms, such that instead of the curved shapes shown on FIG. 4, these could be angular lines, brackets, or other shapes showing the location and direction of reading.

In a plurality of related embodiments, an ending line symbol can indicate an ending line, such that the same line symbol is repeated as a starting line symbol at the begging of the following line. Such a line symbol can for example be a number, a letter, or another symbol.

In a related embodiment, the reader can customize and select particular reading optimization methods, and switch on or off particular features of embodiments of the system for authoring, transforming, and reading text.

In a related embodiment, the enhanced text produced by the manual, semi-automatic or automatic authoring process, can be stored in a plurality of formats, including:
a. any standard text format, including Flat text files, MS Word, PDF, etc.;
b. any standard graphical format, including JPG, TIFF, etc.;
c. a mixed format, including Interactive SVG, HTML5, Flash, etc.
d. any electronic book format, including the publication formats for Amazon Kindle, Apple iBook, etc.

In a related embodiment, the enhanced text can be bi-directional, with or without reverse transposition of individual words. In this manner, a first line read 410 from left to right, is followed by a next line 412 read from right to left; thereby
a. providing an enhanced text version of known bi-directional formats, such as for example ancient Boustrophedon writing; and
b. allowing the reader to avoid the fast eye movement from right to left, necessary for reading of mono-directional text.

In further related embodiments, the bi-directional enhanced text can be further enhanced with arrow and line-numbering guidance symbols as described in related embodiments herein. In such a particular embodiment, a first arrow symbol 414 can guide the reader in the transition from a first line of text to a second line of text, wherein the second line of text is in a reverse right-to-left format. At the end of the second line of text the reader is further guided by a second arrow symbol 416 showing the transition from the second line of text to a third line of text.

In an embodiment, alternating line blocks of enhanced text, can have an alternating formatting, such that a first line block with a pre-determined number of lines can be formatted with a first formatting, and an immediately following second line block with the pre-determined number of lines can be formatted with a second formatting. A line block is defined as a connected block of a predetermined number of text lines.

In a related example embodiment, the predetermined number of lines can be 1, and the first formatting can be a first font color, and the second formatting can be a second font color, whereby an enhanced text alternates line by line between a first font color and a second font color. This can indicate which line follows next, and for bi-directional text, can provide information on the direction of reading.

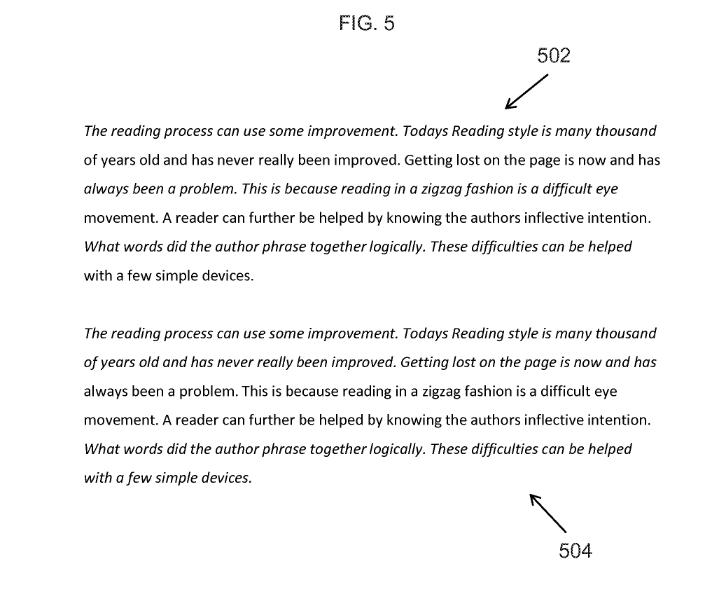

In a related example embodiment 502, shown in FIG. 5, the predetermined number of lines can be 1, and the first formatting can be italic font, and the second formatting can be regular font, whereby an enhanced text alternates line by line between italic font and regular font.

In a related example embodiment 504, the predetermined number of lines can be 2, and the first formatting can be italic font, and the second formatting can be regular font, whereby an enhanced text alternates every second line between italic font and regular font.

In related example embodiments, the optimal predetermined number of lines for alternating line blocks can vary according to user preference. Some user may find that a value of 1 for the predetermined number of lines is preferable. For many users a value of 2 for the predetermined number may be considered optimal in creating a pleasant overview and enhancing the reading speed and reading comprehension. For higher values, such as 4 and higher, less effect may be noticed, but this can vary according to user preference, the type of enhanced text, and the application of reading.

In another embodiment, a footnote 420 can contain a footnote location identifier 422, which is configured to identify the location by line number and word number of the location in the main text of the footnote reference 424. In an example, as illustrated in FIG. 4, a footnote location identifier 422 can be “L3W4”, which identifies the location of the footnote reference 424 as line three, word four. In a further related embodiment, the footnote location identifier can include the page number, such as for example in the form P8L4W8, where the footnote reference is further identified as being located on page eight.

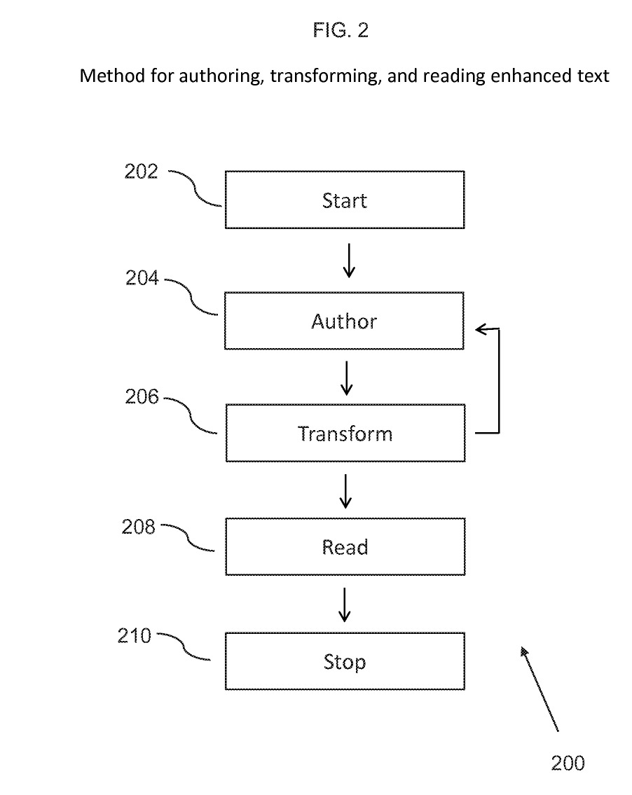

FIG. 2 illustrates a method for authoring, transforming and reading text enhanced with guidance symbols and formatting. The process can begin by proceeding to step 204, “Author”, in which a user can author enhanced text.

Next, in step 206, “Transform”, the text can be transformed from standard text to enhanced text, using predetermined transformation functions. At the conclusion of step 206, the method can go back to step 204 or proceed to step 208.

Following this, in step 208, “Read”, a user reads enhanced text using a device or application, which reads from a repository of enhanced text, presenting this to the user.

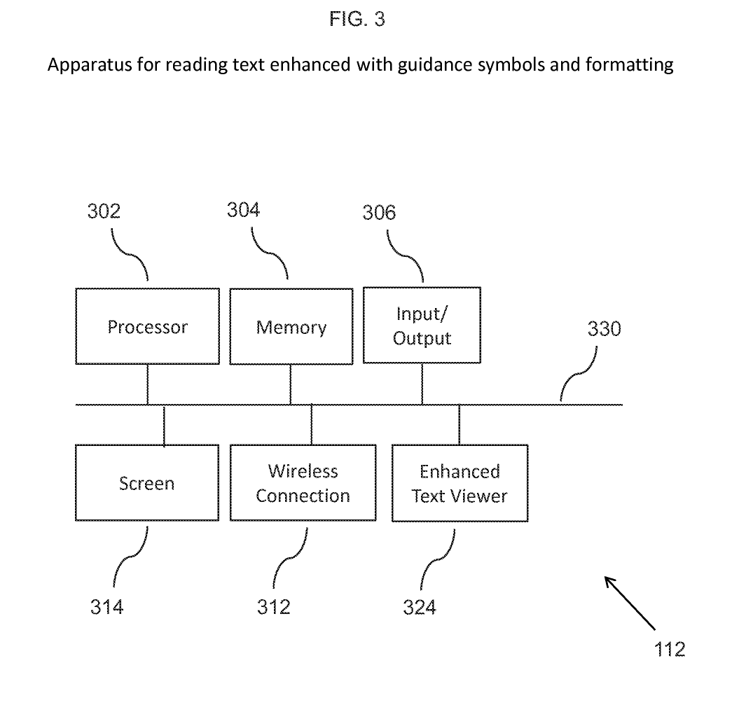

FIG. 3 shows an apparatus for reading text enhanced with guidance symbols and formatting 300, which can include a processor 302, a memory 304, an input/output device 306, a wireless connection 312, a screen 314, and an enhanced text viewer 324, all of which can be interconnected by a data bus 330.

In a further embodiment of the apparatus for reading text enhanced with guidance symbols and formatting 300, the screen 314 can be a touch-enabled screen.

The processor 302, the memory 304, the input/output device 306 and the screen 314, can be part of a general computer, such as a personal computer (PC), a tablet, a notebook, a laptop, a workstation, a server, a mainframe computer, a personal digital assistant (PDA), a smart phone, a mobile device, a similar device, or some combination of these.

In an alternative embodiment, the processor 302, the memory 304, the input/output component 306, and the enhanced text viewer 324 can be part of a specialized computing device, such as a reading tablet or device. The remaining components can include programming code, such as source code, object code or executable code, stored on a computer-readable medium that can be loaded into the memory 304 and processed by the processor 306 in order to perform the desired functions of the apparatus for reading enhanced text 300.

In another alternative embodiment, the processor 302, the memory 304, the input/output component 306, and the enhanced text viewer 324, can be part of a browser based application execution inside a standard web browser.

In yet another alternative embodiment, the processor 302, the memory 304, the input/output component 306, and the enhanced text viewer 324, can be part of a native application execution on top of an operating system and computer execution environment, such as Windows, iOS, Apple O/S, etc.

In various embodiments, the apparatus for reading text enhanced with guidance symbols and formatting 300 can be coupled to a communication network. The communication network can include any viable combination of devices and systems capable of linking computer-based systems, such as:
a. the Internet; an intranet or extranet,
b. a local area network (LAN); a wide area network (WAN);
c. a direct cable connection; a private network; a public network; an Ethernet-based system; a token ring; a value-added network; a telephony-based system, including, for example, T1 or E1 devices; an Asynchronous Transfer Mode (ATM) network; a wired system; a wireless system; an optical system; a combination of any number of distributed processing networks or systems or the like.

An embodiment of the apparatus for reading enhanced text 300 can be coupled to the communication network by way of the local data link, which in various embodiments can incorporate any combination of devices—as well as any associated software or firmware—configured to couple processor-based systems, such as modems, network interface cards, serial buses, parallel buses, LAN or WAN interfaces, wireless or optical interfaces and the like, along with any associated transmission protocols, as may be desired or required by the design.

Additionally, an embodiment of the apparatus for reading enhanced text 300 can communicate information to the user and request user input by way of an interactive, menu-driven, visual display-based user interface, or graphical user interface (GUI). The user interface can be executed, for example, on a personal computer (PC) with a mouse and keyboard, with which the user may interactively input information using direct manipulation of the GUI. Direct manipulation can include the use of a pointing device, such as a mouse, a stylus, or a touch sensitive screen, to select from a variety of selectable fields, including selectable menus, drop-down menus, tabs, buttons, bullets, checkboxes, text boxes, and the like. Nevertheless, various embodiments of the system for authoring, transforming, and reading text may incorporate any number of additional functional user interface schemes in place of this interface scheme, with or without the use of a mouse or buttons or keys, including for example, a trackball, a touch screen or a voice-activated system.

FIGS. 1, 2, and 3 are block diagrams and flowcharts methods, devices, systems, apparatuses, and computer program products according to various embodiments of the present invention. It will be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus according to the present invention can include other means, such as hardware or some combination of hardware and software, including one or more processors or controllers, for performing the disclosed functions.

In this regard, FIGS. 1 and 3 depict the computer devices of various embodiments, including several of the key components of a general-purpose computer by which an embodiment of the present invention may be implemented. Those of ordinary skill in the art will appreciate that a computer can include many more components than those shown in FIG. 3. However, it is not necessary that all of these generally conventional components be shown in order to disclose an illustrative embodiment for practicing the invention. The general-purpose computer can include a processing unit 302 and a system memory 304, which may include various forms of non-transitory storage media such as random access memory (RAM) and read-only memory (ROM). The computer also may include nonvolatile storage memory, such as a hard disk drive, where additional data can be stored.

It shall be understood that the above-mentioned components of the system for authoring, transforming, and reading text enhanced text 100 and the apparatus for reading enhanced text 300 are to be interpreted in the most general manner.

For example, the processor 302 can include a single physical microprocessor or microcontroller, a cluster of processors, a datacenter or a cluster of datacenters, a computing cloud service, and the like.

In a further example, the memory 304 can include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that components in the system for authoring, transforming, and reading text enhanced text 100, and the apparatus for reading enhanced text 300 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components 306, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention, which fall within the true spirit, and scope of the invention.

For example, alternative embodiments can reconfigure or combine the components of the authoring component 104, the text transformation component 106, the enhanced text repository 110, and the enhanced text reader 112. In one such alternative embodiment, the enhanced text repository 110 can be a component within the enhanced text reader 112. In another example embodiment, all the components in the system for reading text enhanced with guidance symbols and formatting 100 can be implemented in a single software application executing on a computer device.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A system for reading enhanced text to increase reading speed and comprehension, comprising:
a) an enhanced text reader for presenting and reading an enhanced text, comprising a standard text enhanced with guidance symbols and guidance formatting, wherein the enhanced text is stored in a non-transitory memory of the enhanced text reader;
whereby a human reader can read the enhanced text.

2. The system for reading enhanced text of claim 1, further comprising
a) an enhanced text repository, wherein is stored an enhanced text;
wherein the enhanced text is retrieved by the enhanced text reader from the enhanced text repository; whereby a human reader can optimize reading comprehension and speed.

3. The system for reading enhanced text of claim 2, further comprising
a) a standard text repository; and
b) a text transformation component for transforming a standard text, wherein the standard text is retrieved from the standard text repository and transformed to an enhanced text by the text transformation component, by application of text transformations that insert guidance symbols and guidance formatting, and wherein further the enhanced text is subsequently stored in the enhanced text repository;
whereby the standard text is transformed to enhanced text.

4. The system for reading enhanced text of claim 2, further comprising an authoring component for a user to author an enhanced text, wherein a user can edit an enhanced text, and store the resulting enhanced text in the enhanced text repository.

5. The system for reading enhanced text of claim 4, further comprising
a standard text repository, wherein the authoring component can retrieve standard text from the standard text repository for further authoring;
whereby a user can edit an enhanced text using partially or wholly standard text as input.

6. The system for reading enhanced text of claim 1, wherein the enhanced text further comprises a line number guidance symbol, comprising:
a) an ending line number, wherein the ending line number is applied to the end of a first line of text; and
b) a beginning line number, wherein the beginning line number is applied to the beginning of a second line of text, immediately following the first line of text;
whereby a reader can match the ending line number with the beginning line number, and thereby be guided with respect to the direction and flow of reading.

7. The system for reading enhanced text of claim 1, wherein the enhanced text further comprises an arrow guidance symbol, comprising:
a) a first arrow symbol applied to the end of a first line of text; and
b) a second arrow symbol, applied to the beginning of a second line of text, immediately following the first line of text;
whereby a reader can be guided to the beginning of the second line and the direction of further reading.

8. The system for reading enhanced text of claim 1, wherein the enhanced text further comprises an arrow and line guidance symbol, comprising:
a) a first arrow symbol applied to the end of a first line of text;
b) a line indicator, whereby the line indicator indicates the direction of reading to a next following line of text, immediately following the first line of text; and
c) a second arrow symbol, applied to the beginning of the next following line;
wherein the line indicator connects from the first arrow symbol to the second arrow symbol; whereby the beginning of the next following line, and the direction of further reading is indicated.

9. The system for reading enhanced text of claim 1, wherein the enhanced text further comprises a footnote location identifier, wherein a footnote can contain the footnote location identifier, wherein the footnote location identifier is configured to identify the location of a footnote reference in the enhanced text.

10. The system for reading enhanced text of claim 1,
wherein the enhanced text further comprises bi-directional text, so that a first line to be read from left to right, is followed by a second line to be read from right to left;
whereby a user can eliminate the need for a fast eye movement from right to left, and thereby further optimize reading comprehension and speed.

11. The system for reading enhanced text of claim 1,
wherein the enhanced text further comprises guidance formatting in the form of alternating line blocks of enhanced text, such that a first line block with a pre-determined number of lines is formatted with a first formatting, and an immediately following second line block with the pre-determined number of lines is formatted with a second formatting;
whereby a reader can be guided with respect to the direction of reading by alternating guidance formatting of consecutive line blocks, and thereby further optimize reading comprehension and speed.

12. The system for reading enhanced text of claim 11, wherein the pre-determined number of lines for the first and the second line block is 2.

13. The system for reading enhanced text of claim 11, wherein the first formatting is a first font color, and the second formatting is a second font color, whereby the enhanced text is formatted such that alternating line blocks have alternating font colors.

14. A method for reading enhanced text to increase reading speed and comprehension, comprising:
reading enhanced text, wherein the enhanced text comprises a standard text enhanced with guidance symbols and guidance formatting, wherein the enhanced text is presented to a user for reading;
whereby a human reader can receive guidance on the location of words in the enhanced text.

15. The method for reading enhanced text of claim 14, further comprising a preceding act of:
authoring the enhanced text, wherein a human author can write text and apply a further set of guidance symbols and guidance formatting to the enhanced text.

16. The method for reading enhanced text of claim 14, further comprising a preceding act of:
transforming a text, wherein a set of guidance symbols and guidance formatting are applied to the text, transforming it into an enhanced text.

17. The method for reading enhanced text of claim 14, wherein the enhanced text further comprises a line number guidance symbol, comprising:
a) an ending line number, wherein the ending line number is applied to the end of a first line of text; and
b) a beginning line number, wherein the beginning line number is applied to the beginning of a second line of text, immediately following the first line of text;
whereby a reader can match the ending line number with the beginning line number, and thereby be guided with respect to the direction and flow of reading.

18. The method for reading enhanced text of claim 14, wherein the enhanced text further comprises an arrow guidance symbol, comprising:
a) a first arrow symbol applied to the end of a first line of text; and
b) a second arrow symbol, applied to the beginning of a second line of text, immediately following the first line of text;
whereby a reader can be guided to the beginning of the second line and the direction of further reading.

19. The method for reading enhanced text of claim 14, wherein the enhanced text further comprises an arrow and line guidance symbol, comprising:
a) a first arrow symbol applied to the end of a first line of text;
b) a line indicator, whereby the line indicator indicates the direction of reading to a next following line of text, immediately following the first line of text; and
c) a second arrow symbol, applied to the beginning of the next following line;
wherein the line indicator connects from the first arrow symbol to the second arrow symbol; whereby the beginning of the next following line, and the direction of further reading is indicated.

20. The method for reading enhanced text of claim 14, wherein the enhanced text further comprises a footnote location identifier, wherein a footnote can contain the footnote location identifier, wherein the footnote location identifier is configured to identify the location of a footnote reference in the enhanced text.

21. The method for reading enhanced text of claim 14,
wherein the enhanced text further comprises bi-directional text, so that a first line to be read from left to right, is followed by a second line to be read from right to left;
whereby a user can eliminate the need for a fast eye movement from right to left, thereby further optimizing reading comprehension and speed.

22. An apparatus for reading enhanced text to increase reading speed and comprehension, comprising:
a) a processor;
b) a non-transitory memory;
c) a screen;
wherein the processor can load an enhanced text from the non-transitory memory, and present the enhanced text on the screen, whereby a user can read the enhanced text.

23. The apparatus for reading enhanced text of claim 22, further comprising:
d) an enhanced text viewer;
wherein the enhanced text can be loaded from the memory by the processor, and presented on the screen by the enhanced text viewer,
whereby a user can read the enhanced text.

24. The apparatus for reading enhanced text of claim 22, wherein the enhanced text further comprises a line number guidance symbol, comprising:
a) an ending line number, wherein the ending line number is applied to the end of a first line of text; and
b) a beginning line number, wherein the beginning line number is applied to the beginning of a second line of text, immediately following the first line of text;
whereby a reader can match the ending line number with the beginning line number, and thereby be guided with respect to the direction and flow of reading.

25. The apparatus for reading enhanced text of claim 22, wherein the enhanced text further comprises an arrow guidance symbol, comprising:
a) a first arrow symbol applied to the end of a first line of text; and
b) a second arrow symbol, applied to the beginning of a second line of text, immediately following the first line of text;
whereby a reader can be guided to the beginning of the second line and the direction of further reading.

26. A method to increase reading speed and comprehension, comprising reading content adapted to use added visual guidance location symbols or formatting, to guide reader eye focus.
